(19) United States
(12) Patent Application Publication
(10) Pub. No.: US 2026/0326832 A1
(43) Pub. Date: Oct. 22, 2026

(54) COMPOSITE RV STRUCTURE

(71) Applicant: PATRICK INDUSTRIES, INC., Elkhart, IN (US)

(72) Inventors: Hugo Enrique Gonzalez, LaPorte, IN (US); Roger David Plaster, Middlebury, IN (US); Brock Allyn Doty, Wakarusa, IN (US); Samuel David Irick, Bristol, IN (US); Kyle Alexander Look, Granger, IN (US)

(73) Assignee: PATRICK INDUSTRIES, INC., Elkhart, IN (US)

(21) Appl. No.: 19/382,864

(22) Filed: Nov. 7, 2025

Related U.S. Application Data
(60) Provisional application No. 63/868,751, filed on Aug. 22, 2025.

(51) Int. Cl. B62D 29/04; B32B 27/12; B32B 27/36; B60P 3/32; B62D 25/06

(52) U.S. Cl. CPC B62D 29/043; B32B 27/12; B32B 27/36; B62D 25/06; B32B 2250/03; B32B 2250/40; B32B 2260/021; B32B 2260/046; B32B 2262/101; B32B 2262/144; B32B 2262/148; B32B 2266/0264; B32B 2266/08; B32B 2307/72; B32B 2307/7376; B32B 2605/00; B60P 3/32

(57) ABSTRACT

A roof structure for recreational vehicles includes at least one structural member having a central portion that is elevated relative to end or edge portions thereof. The roof structure further includes at least one composite panel disposed on the upper side of the structural member. The composite panel may comprise a polymer foam core that is disposed between an upper layer and a lower layer. The upper and lower layers may comprise reinforcing material disposed in a polymer matrix. The composite panel may be curved during assembly of the roof structure, and side or edge portions of the composite panel may be secured to the structural member and/or walls, whereby a central portion of the composite panel is elevated relative to side portions of the composite panel. A waterproof membrane may be adhesively adhered to the composite panel by a reactive adhesive.

### CROSS-REFERENCE TO RELATED APPLICATION

This application claims priority to and the benefit under 35 U.S.C. § 119(e) of U.S. Provisional Patent Application No. 63/868,751, filed on Aug. 22, 2025, entitled COMPOSITE RV STRUCTURE, the entire disclosure of which is hereby incorporated herein by reference.

### BACKGROUND

The present disclosure generally relates to a recreational vehicle (RV) having a composite structure, and more particularly to a composite roof structure.

Various RV roof structures have been developed. Known RV roof structures may comprise sheets of wood and waterproof membranes that are adhered to the sheets of wood by moisture curing adhesive.

### SUMMARY

An aspect of the present disclosure is a roof structure for recreational vehicles having upright walls on opposite sides thereof. The roof structure includes a roof support structure. The roof support optionally comprises at least one rafter or truss having opposite portions that are configured to extend between walls of a recreational vehicle (RV), wherein an upper side of the roof support structure includes a central portion that is elevated relative to opposite portions of the upper side of the roof support structure. The roof support further includes at least one composite panel disposed on the upper side of the roof support. The composite panel comprises a polymer foam core that is disposed between an upper layer and a lower layer. The polymer foam core may optionally comprise a thermoplastic polymer material. The upper and lower layers may optionally comprise reinforcing material that is disposed in a polymer matrix. The matrix may optionally comprise a thermoplastic polymer material. The composite panel is deformed during assembly of the roof structure, and the side portions of the composite panel adjacent the opposite portions of the roof support are secured to the roof support and/or to the walls, whereby the composite panel defines a curvature and a central portion of the composite panel is elevated relative to the side portions of the composite panel.

The thermoplastic polymer foam core of the composite panel may optionally comprise a polyethylene terephthalate (PET) foam, and the upper and lower layers of the composite panel may also comprise a thermoplastic polymer (e.g. PET). At least one of the upper and lower layers may optionally comprise polymer or glass fibers disposed in a thermoplastic polymer (e.g. PET) matrix. The upper and lower layers may both optionally comprise glass fibers disposed in a thermoplastic polymer matrix (e.g. PET).

The fibers may optionally extend in first and second directions, wherein the first direction is orthogonal relative to the second direction. The fibers may optionally comprise non-woven fiberglass mat. The fibers may, alternatively, comprise woven fiberglass mat.

The composite panel may optionally have a thickness of less than about 1 inch, ¾ inch, or ½ inch (e.g. less than about 0.4 inches). The upper and lower layers may have the equal thickness, or they may have unequal thicknesses. The upper layer may optionally have a thickness of about 0.05 inches, and the lower layer may also have a thickness of about 0.05 inches. However, the upper layer may have a thickness of about 0.010 inches to about 0.25 inches or virtually any other suitable thickness. The lower layer may also have a thickness of about 0.10 inches to about 0.25 inches.

The upper layer may optionally be in tension due to the curvature formed in the composite panel during assembly, and the lower layer may optionally be in compression due to curvature formed in the composite panel during assembly.

The roof structure may optionally include threaded fasteners securing the side portions of the composite panel to the roof structure and/or the walls. The roof structure may optionally include adhesive securing the side portions of the composite panel to the roof structure and/or to the walls.

The upper side of the roof structure may optionally have a convex central surface, and the lower layer of the composite may optionally abut (e.g. contact) the convex central surface of the roof structure.

The roof structure may optionally comprise first and second trusses that are spaced apart, wherein the first and second trusses have an upper side that includes a convex central portion. The composite panel may include outer side edges adjacent to the side portions of the composite panel, and first and second transverse side edges extending between the first outer side edges. Central portions of the first and second transverse side edges may optionally be positioned directly above the first and second trusses, respectively.

The first composite panel may optionally comprise a first composite panel, and the roof structure may optionally include a second composite panel that is positioned adjacent the first composite panel. The second composite panel may optionally have an edge positioned directly above the first truss whereby the first and second composite panels form a seam extending over the first truss. The roof structure may optionally include threaded fasteners extending through the first and second composite panels and into the first truss adjacent to opposite sides of the seam.

The first and second trusses may optionally include a linear lower truss member and a curved upper truss member. Opposite ends of the curved upper truss members may optionally be spaced inwardly from opposite ends of the linear lower truss members to form gaps. Portions of the first and second composite panels may optionally extend past the opposite ends of the curved upper truss members and over the gaps.

The foam core may optionally comprise closed cell PET foam having a density of about 2 lb per cubic foot to about 10 lb per cubic foot. The foam core may optionally comprise closed cell PET form having a density of about 6 lb per cubic foot to about 7 lb per cubic foot. The upper and the lower layers may optionally comprise greater than 50% PET by weight, and less than 50% by weight glass fibers (e.g. 53% PET, 47% glass fibers). Upper and lower sides of the foam core may be heat welded to the upper and lower layers, respectively.

The roof structure may optionally include a flexible waterproof membrane that is adhesively bonded to the upper layer of the composite panel. The adhesive may optionally comprise a reactive adhesive that cures via a chemical reaction.

The flexible waterproof membrane and the upper layer of the composite panel may optionally be non-porous, and the adhesive may optionally comprise first and second parts that are mixed to create a chemical reaction causes the adhesive to cure without evaporation or outgassing.

When cured, the adhesive preferably provides a peel strength that is at least as great as minimum peel strength. The minimum peel strength may be determined utilizing a 180 °F peel strength test (according ASTM D903) after 24 hours at room temperature and/or after longer periods of time during which the adhesive is exposed to a series of high and low temperature cycles (e.g. 5 cycles, each cycle including 10 hours at 180 °F and 10% relative humidity (RH), followed by a 2 hour transition, 10 hours at −40 °F and 0% RH, 2 hour transition, 10 hours at 100 °F and 90% RH, a 2 hour transition back to the first setting). The peel strength between the flexible waterproof membrane and the upper layer of the composite panel is preferably at least 1 lb per linear inch for adhesive temperatures in a range of about- 40 °C to about 70 °C. The peel strength is more preferably about 3-4 lb per linear inch for adhesive temperatures in a range of about- 40 °C to about 70 °C, and more preferably at least about 15 lb per linear inch for adhesive temperatures in a range of about −40 °C to about 70 °C. The adhesive may, alternatively, provide the 180° peel strengths noted above at other temperature ranges of at least 1 lb per linear inch for adhesive temperatures in a range of about −20 °C to about 70 °C. The peel strength is more preferably about 3-4 lb per linear inch for adhesive temperatures in a range of about −20 °C to about 70 °C, and more preferably at least about 15 lb per linear inch for adhesive temperatures in a range of about- 20 °C to about 70 °C. These peel strengths are preferably achieved 24 hours or less after the adhesive components are mixed.

When at least partially cured, the adhesive may optionally have a thickness of about 5 or 10 mils to about 20, 30, 40, or 50 mils in any combination, and more preferably about 6mils to about 18 mils. The adhesive optionally comprises a polyol component and a Methyl Isocyanate (e.g. Methylenediphenyl Diisocyanate (MDI)) that react upon mixing.

The flexible waterproof membrane may optionally have a thickness in a range of about 0.010 inches to 0.125 inches, about 0.025 inches to about 0.060 inches, or about 0.030 inches, about 0.004 inches, or about 0.050 inches. The flexible waterproof membrane optionally comprises an elastomeric polymer (e.g. rubber) and may comprise a material selected from the group consisting of: Thermoplastic Polyolefin (TPO), Polyvinyl Chloride (PVC), and Ethylene Propylene Diene Monomer (EPDM).

The central portion of the composite panel is optionally elevated at least about two inches relative to the side portions of the composite panel, and the roof structure may be about 6-10 feet wide.

The curvature of the central portion of the composite panel optionally defines a constant radius, and the side portions of the composite panel may optionally have less curvature than the central portion of the composite panel. The central portion of the composite panel may have a convex curvature, and the side portions may optionally have a concave curvature.

The composite panel optionally comprises a unitary one-piece structure that extends from a front portion of an RV (e.g. a front wall) to a rear portion of the RV (e.g. a rear wall). The RV optionally includes a plurality of trusses or other suitable roof structures extended between upright sidewalls of the RV, and the composite panel may extend over a plurality of trusses.

The RV optionally comprises a trailer having wheels and a trailer hitch.

The RV may include upright sidewalls and a floor structure. Each sidewall may comprise frame members and at least one upright composite panel secured to the frame members of the sidewalls. The floor optionally includes a rigid frame structure and a composite floor panel extending between upright sidewalls of the RV. The composite floor panel optionally comprises a PET foam core that is bonded to fiber reinforced PET upper and lower layers.

Another aspect of the present disclosure is a method of installing a composite roof on a recreational vehicle (RV), wherein the RV has a structure including a roof support structure. The method includes positioning at least one composite panel over the roof support structure. The roof support structure includes: 1) side portions that are adjacent to upright side walls of the RV, and: 2) a central portion that is elevated relative to the side portions. The composite panel includes a polymer foam core that is bonded to upper and lower layers, wherein the upper and lower layers comprise reinforcing material (e.g. fibers) disposed in a polymer matrix. The method further includes securing side portions of the composite panel to the structure of the RV, whereby a central portion of the composite panel above the central portion of the roof support structure is elevated relative to the side portions of the composite panel.

The side portions of the composite panel are optionally secured to the structure of the RV by driving threaded fasteners through the composite panel into the RV structure. The method optionally includes adhesively bonding a waterproof membrane to the upper layer of the composite panel using an adhesive. The adhesive optionally comprises a reactive adhesive that includes first and second parts that are mixed to form an adhesive that is initially uncured. The method may include depositing the adhesive onto the upper layer of the composite panel while the adhesive is at least partially uncured.

The method may further include spreading the adhesive on the upper layer of the composite panel while the adhesive is at least partially uncured to reduce a maximum thickness of the at least partially uncured adhesive to less than a predefined thickness to thereby increase a curing time of the adhesive. The waterproof membrane may be positioned on the adhesive before the adhesive cures sufficiently to interfere with, or prevent, proper adhesion, and force may be applied to the waterproof membrane to push the waterproof membrane into the adhesive while the adhesive is at least partially uncured. The method optionally includes treating a lower surface of the waterproof membrane (e.g. utilizing corona or plasma treatment) whereby the lower surface has a surface energy of at least about 40 dynes to about 60 dynes (or greater) when the waterproof membrane contacts the adhesive. A viscosity of the adhesive may increase after the first and second parts the adhesive are mixed, and the viscosity of the adhesive may increase more rapidly in first regions of the adhesive having a greater thickness relative to second regions of the adhesive.

Prior to full curing, the at least partially uncured adhesive may be spread to a thickness that is less than a predefined maximum initial thickness within a minimum initial period of time after the first and second parts of the adhesive are mixed, whereby the adhesive remains in a bondable state (e.g. at least partially uncured) in which the waterproof membrane can be adhesively bonded to the upper layer of the composite panel. The minimum initial period of time may be at least about 2 minutes, 4 minutes, 5 minutes, or about 6 minutes. The adhesive may be in a partially uncured state bondable state for at least about 20 minutes following mixing of the first and second parts of the adhesive if the adhesive is less than the maximum thickness within the initial minimum time. In the bondable state the adhesive may be at least partially uncured. If the adhesive is initially applied in a sufficiently thin layer (e.g. by spraying) that is less than the predefined maximum initial thickness, it may not be necessary to spread the adhesive into a layer.

A majority of the adhesive between the membrane and the upper layer of the composite panel may have a thickness of about 10 mils to about 18 mils after applying force to the waterproof membrane to push the waterproof membrane into the adhesive.

The method may optionally include driving threaded fasteners through at least the side portions of the composite panel into structures disposed adjacent to upper portions of the upright side walls of the RV. The structure may optionally comprise headers or the like extending along upper portions of the wall.

The roof support structure may optionally comprise a plurality of trusses, each having opposite ends that are supported by the upright side walls of the RV, and the trusses may optionally include curved upper support structures extending along an upper side of the truss. The method may optionally include driving threaded fasteners through the composite panel into the curved upper support structures of at least a pair of the trusses.

The method may optionally include covering upper ends of the threaded fasteners with the waterproof membrane.

A first part of the adhesive may optionally comprise a polyol, and a second part of the adhesive may optionally comprise an isocyanate that reacts with the polyol upon mixing. The first part of the adhesive optionally comprises castor oil, Dipropylene Glycol (DPG), a moisture scavenging agent, and an organotin catalyst. The method optionally includes mixing equal (or unequal) volumes of first and second parts of the adhesive.

The method optionally includes adhesively bonding a waterproof membrane to the upper layer of the composite panel using a pressure sensitive adhesive (PSA). A layer of the PSA may be disposed on a lower side of the waterproof membrane wherein the layer of PSA is initially covered by a release layer or liner. The method optionally includes removing the release layer to expose the PSA, and the waterproof membrane may be positioned on the upper layer of the composite panel with the PSA in contact with the upper layer of the composite panel. The PSA optionally comprises hot melt adhesive.

The method optionally includes treating an upper surface of the upper layer of the composite panel whereby the surface energy of the upper layer of the composite panel is at least about 40 dynes prior to adhering the waterproof membrane to the upper layer of the composite panel.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a perspective view of a recreational vehicle (RV) according to an aspect of the present disclosure;

FIG. 2 is a partially fragmentary cross-sectional view of the RV of FIG. 1 taken along the lines II-II of FIG. 1;

FIG. 3 is a fragmentary view of a portion of the RV of FIG. 2;

FIG. 3A is a fragmentary view of a portion of the RV of FIG. 2 showing an alternative truss structure;

FIG. 4 is a fragmentary view of a portion of the RV of FIG. 2;

FIG. 5 is a partially schematic view showing assembly of a roof structure of the RV of FIG. 1;

FIG. 6 is a partially schematic view showing assembly of a roof structure of the RV of FIG. 1;

FIG. 7 is a perspective view of a roof structure of an RV according to an aspect of the present disclosure;

FIG. 8 is a fragmentary view of a portion of the roof structure of FIG. 7 taken along the line VIII;

FIG. 9 is a partially schematic perspective view of a roof structure during assembly;

FIG. 10 is a fragmentary cross-sectional view of roof structure during assembly according to an aspect of the present disclosure;

FIG. 11 is a fragmentary cross-sectional view of roof structure during assembly according to an aspect of the present disclosure;

FIG. 12 is a partially exploded perspective view of a roof structure according to an aspect of the present disclosure;

FIG. 13 is a fragmentary cross-sectional view of a wall of the RV of FIG. 2; and

FIG. 14 is a cross-sectional view of a slide out of the RV of FIG. 1 taken along the line XIV.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

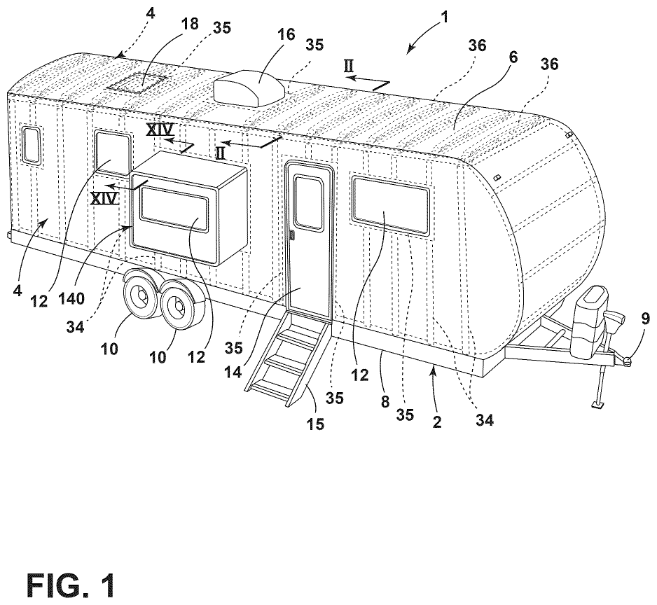

With reference to FIG. 1, a Recreational Vehicle (RV) 1 according to an aspect of the present disclosure generally includes a base 2, upright sidewalls 4, and a roof 6. Base 2 may include a frame 8 and hitch 9 whereby the RV 1 can be towed by a motor vehicle or the like. RV 1 may also include one or more wheels 10. In the illustrated example, RV 1 comprises a trailer. However, RV 1 may comprise a fifth wheel, a class A, class B, or class C RV, a truck camper, or other RV. As used herein, the term RV may encompass virtually any mobile structure, including without limitation, wheeled vehicles, trailers, boats, etc.

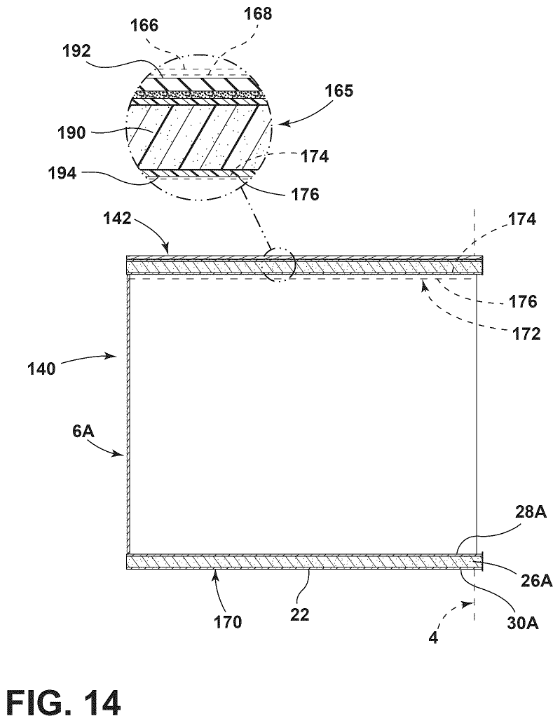

RV 1 may include one or more windows 12 and one or more doors 14, and may further include steps 15 that can be moved from a stored position to a deployed position to facilitate entry and exit into and out of the RV 1. RV1 may optionally include an air conditioning (AC) unit 16, and one or more skylights 18. As discussed below, in connection with FIG. 14, RV 1 may include a slide out 140 having a composite roof 142 and a composite floor 144.

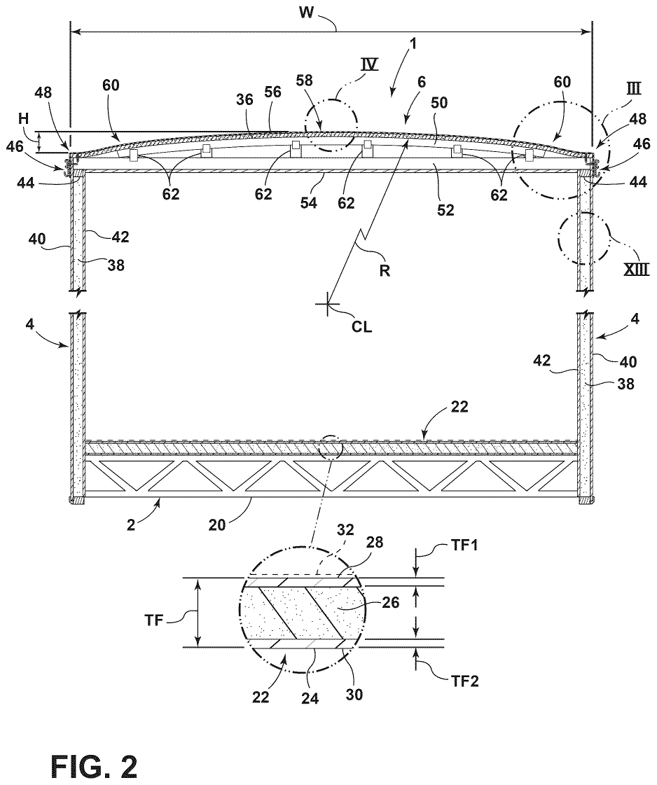

With further reference to FIG. 2, base 2 may comprise a frame 20 and a floor structure 22. Frame 20 may comprise metal or other suitable material. Floor structure 22 may comprise, optionally, a composite floor panel 24 having a foam core 26 and upper and lower layers 28 and 30, respectively. Floor structure 22 may optionally be covered by a floor covering material 32, which may comprise, for example, wood or polymer material that is configured to have the appearance of wood, tile, or other material. The foam core 26 may optionally comprise thermoplastic polymer material such as Polyethylene terephthalate (PET), and the upper and lower layers 20 and 30 may optionally comprise a thermoplastic polymer material (e.g. PET) that is bonded to the foam core 26. The upper and lower layers 20 and 30 may include reinforcing fibers disposed in a PET matrix of the upper and lower layers 30. Core 26 may have a first density, layers 20 and 30 may have a second density, and the reinforcing fiber may have a third density, wherein the first density may be less than the second density, and the third density may be greater than the second density. The reinforcing fiber of the upper and lower layers 20 and 30 may comprise PET, fiberglass, or other suitable material. In a preferred embodiment, the reinforcing fibers of layers 20 and 30 may comprise continuous polymer fibers (e.g. PET) disposed in an amorphous polymer matrix (e.g. PET), wherein “continuous fiber” designates a fiber where the mechanical properties no longer respond to an increase in fiber length. Foam core 26 may comprise a closed cell foam. The thickness TF of the composite floor panel 24 may be about 9 mm to about 30 mm, more preferably between about 16 mm and about 30 mm, and most preferably between about 19 mm and about 25 mm. The thicknesses of the layers 20 and 30 may be equal or unequal. The upper and lower layers 20 and 30 may preferably have a thickness within the range of about 1 mm and about 2 mm, more preferably between about 1.1 mm and about 1.5 mm, and most preferably between about 1.2 mm and about 1.4 mm. The upper and lower layers 20 and 30 may be bounded to foam core 26 by heat welding, adhesive, or other suitable technique. Floor structure 22 may optionally include an additional layer of foam (e.g. polystyrene) (not shown), below composite floor panel 24, and one or more additional layers (not shown) of fiberglass or other suitable protective material below the polystyrene foam layer.

The construction of composite floor panel 24 may provide a screw-holding tensile force within a range of between about 700 N to about 1000 N, more preferably between about 800 N and about 900 N, each based on a 4.2 mm threaded screw with 15 mm±of complete threads engaging upper and/or lower layers 20 and 30 (e.g. European standard BS EN-320). Further, the floor structure 22 is configured to provide an impact strength that is preferably within a range of between about 147 J and about 299 J, and more preferably between about 220 J and about 299 J without stratified fracture based on a solid steel ball of 10.17 kg weight falling from a freefall weight test height of 1.5-3 m. The floor structure 22 is also configured to provide zero or no deformation subsequent to a load removal test based on a 1 m², 1,000 kg uniform load test.

The upright side walls 4 of RV 1 may include a plurality of upright metal or wood frame members 34 (FIG. 1) that may be aligned with roof trusses 36. Additional frame members 35 may be positioned around windows 12, doors 14, AC unit 16, and skylights 18. Upright side walls 4 may include a header 44 or other structure extending along upper portions 46 of the sidewalls 4, and opposite ends 48 of trusses 36 may be supported on the header 44 or other wall structure. As discussed in more detail below, trusses 36 may optionally include an upper member 50 and lower member 52. A ceiling panel 54 may be positioned below trusses 36.

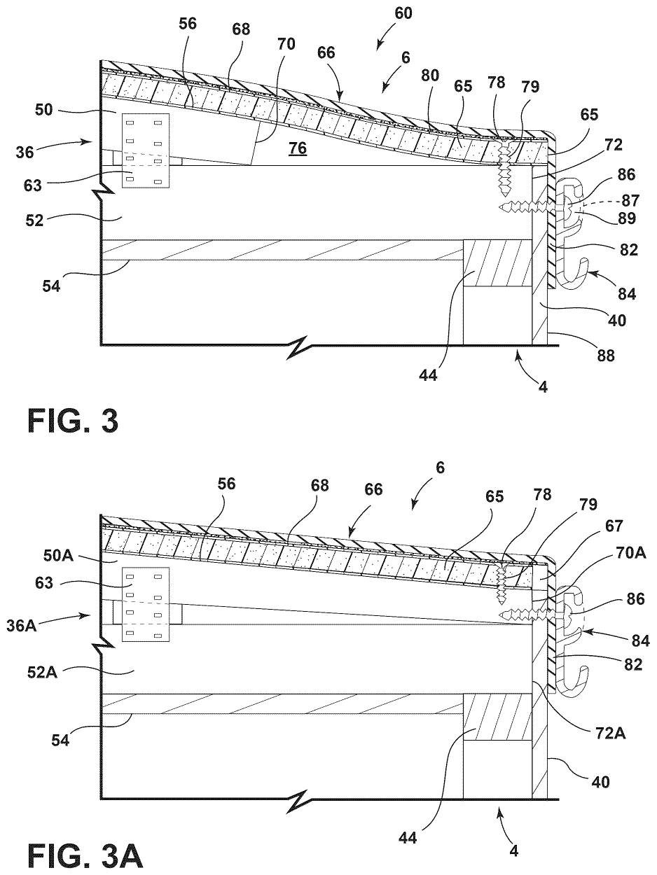

With reference to FIGS. 2 and 3, upper sides 56 of trusses 36 include central portions 58 between outer portions 60 of trusses 36. The upper portions 56 may have a convex curvature, and upper portions 56 may optionally have a constant radius R about a center line CL that extends in a fore-aft direction of RV 1, whereby a central portion of upper surface 80 of composite panel(s) 65 may have a convex curvature that may have a constant radius R. However, the upper sides 56 of trusses 36 may have other shapes, and the present disclosure not limited to a constant radius R.

Central portions 58 of trusses 36 may be elevated relative to outer portions 60 of trusses 36, whereby the central portion of roof 6 is at a height H (FIG. 2) relative to outer portions of roof 6 adjacent sidewalls 4. Height H may be about, for example, 2 inches to about 6 or 8 inches. The roof 6 may have a width W that is about 7-10 feet, and typically about 8 feet to about 8.5 feet. Width W is preferably equal to, or less than, a maximum width that can be towed on public roads without a permit. The curvature of the roof 6 is preferably sufficient to prevent pooling of water on the roof 6. Trusses 36 may include a plurality of upright reinforcing structures 62 that are disposed between upper and lower truss members 50 and 52. Truss members 50 and 52 and reinforcing members 62 may comprise, for example, wood or other suitable material. If trusses 36 comprise wood, nail plates 63 may be utilized to interconnect the upper and lower members 50 and 52 in a manner that is generally known in the art. In the illustrated example, upper truss member 50 is curved, and lower truss member 52 is linear. However, lower truss member 52 may be curved, whereby the ceiling panel 54 has a concave lower surface. Trusses 36 may be formed from metal, polymer, fiberglass, or other suitable material. Trusses 36 may be positioned on, for example, 16 inch, 24 inch, 32 inch, or 36 inch centers.

With further reference to FIG. 3, roof 6 further includes at least one composite sheet or panel 65 that is positioned on a suitable roof structure such as trusses 36. Roof 6 optionally includes a flexible waterproof membrane 66 that is positioned on the upper side of composite panel 65. As discussed in more detail below, waterproof membrane 66 may be secured to the composite panel 65 by an adhesive 68. Waterproof membrane 66 is optional, and the upper side of composite panel 65 may be exposed if roof 6 does not include a waterproof membrane. In the example of FIG. 3, end 70 of upper truss member 50 is offset from end 72 of lower truss member 52 to thereby form a gap 76. The composite panel 65 extends over the gap 76, and the outer portions 60 of the composite panel 65 may be secured to the trusses 36 and/or wall structures 4 by threaded fasteners 78 that are driven through the composite panel 65 into the trusses 36 and/or wall structures 4. Outer portions 60 may optionally have a concave surface (e.g. above gap 76). When threaded fasteners 78 are fully installed, heads 79 of threaded fasteners 78 are preferably flush with upper surface 80 of composite panel 65, whereby waterproof membrane 66 has a contour that closely matches the contour of upper surface 80 of composite panel 65. Edges or flaps 82 of waterproof membrane 66 may be adhesively secured to outer surfaces 88 of outer layers 40 of wall 4 utilizing 2-sided tape (not shown), and drip rail 84 may be secured to the trusses 36 and/or wall structures 4 utilizing threaded fasteners 86 in a manner that is generally known in the art. A polymer cover 87 may be positioned in channel 89 of drip rail 84 to cover threaded fasteners 86 in a known manner.

With further reference to FIG. 3A, roof 6 may, alternatively, comprise a plurality of roof trusses 36A having upper and lower members 50A and 52A, respectively. End 70A of upper member 50A is vertically aligned with end 72 a of lower truss member 52A. In the example of FIG. 3A, the edges 82 of the roof membrane 66 wrap around ends 67 of composite panel 65. Edges 82 may be secured utilizing 2-sided tape and a drip rail 84 in substantially the same manner as described above in connection with FIG. 3. It will be understood that the roof 6 may comprise virtually any suitable support structure that is capable of supporting one or more composite panels. Such roof support structures may be configured to support composite panel 65 in a curved shape or other shape having an elevated or raised central portion. Thus, the present disclosure is not limited to the examples of FIGS. 3 and 3A.

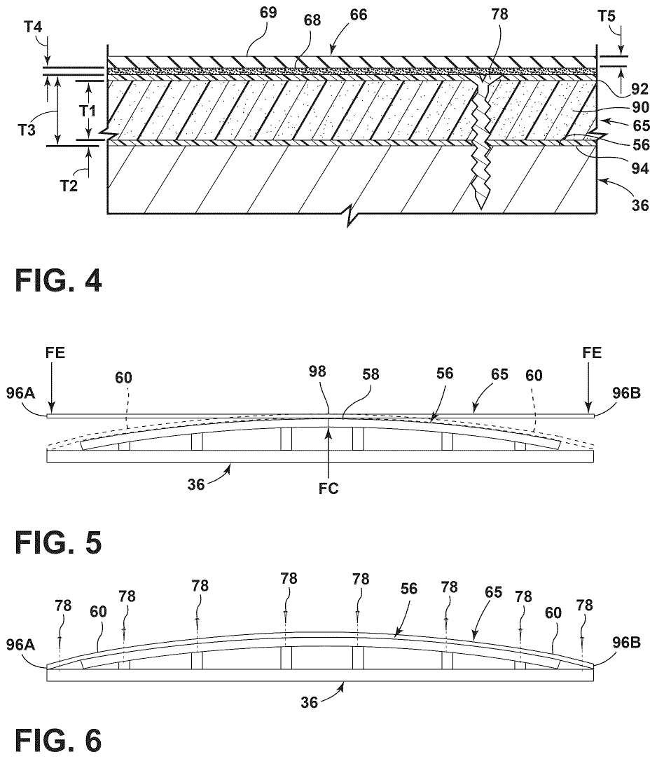

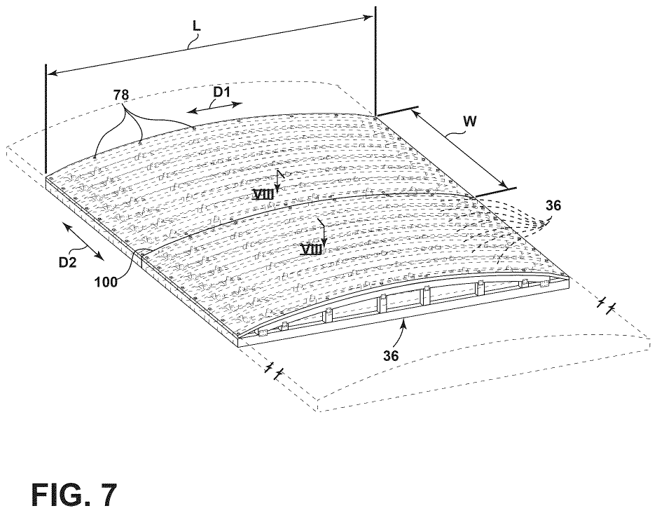

With further reference to FIG. 4, composite panel 65 includes a foam core 90, an upper layer 92, and a lower layer 94. Foam core 90 may comprise a thermosetting or thermoplastic foam that is open or closed cell. For example, foam core 90 may optionally comprise closed cell polyethylene terephthalate (PET) foam having a density of about 2lb/cubic foot to about 10 lb/cubic foot, or more preferably about 6 lb/cubic foot to about 7 lb/cubic foot. Upper and lower layers 92 and 94 may comprise a thermoplastic polymer material. According to an example, upper and lower layers 92 and 94 comprise polyethylene terephthalate (PET) with or without reinforcing material disposed in the PET, and may comprise a PET matrix having reinforcing material (e.g. glass or PET fibers) disposed in the matrix (e.g. PET or thermosetting polymer) to provide reinforcement. The fibers may comprise glass fibers that extend in first and second directions D1 and D2 (FIG. 7), wherein direction D1 and D2 are orthogonal to one another. The fibers may be any length and orientation as required for a particular application. In an example, the fibers may comprise “short” glass fibers having lengths ranging from less than 1 mm to several mm. The fibers may optionally comprise first and second layers extending in directions D1 and D2, respectively. However, a single layer of fibers (e.g. glass fibers) extending in a single direction may be utilized, and three or more layers may also be utilized depending on the specific stiffness and strength requirements of a particular application.

According to an example, layers 92 and 94 of sheet or panel 65 may comprise about 50% by weight polymer matrix and about 50% by weight glass fibers. In general layers 92 and 94 may comprise about 40%-60% by weight polymer matrix and about 40% to about 60% by weight glass fibers. In the example of FIG. 7, the composite panels 65 may have a width W of about 4 feet and a length L of about 8 feet. If a roof 6 includes a plurality of panels 65, the edges of adjacent panels 65 typically form seams 100 (e.g. FIG. 7). However, composite panels 65 may have virtually any suitable dimensions. For example, the roof 6 of RV 1 may be covered by a single (one piece) composite panel 65 that is free of seams 100. If a single composite panel 65 is utilized, the panel 65 may be about 7-10 feet wide, and the panel may extend the length of roof 6, whereby the panel is, for example, 10 feet long, 20 feet long, 30 feet long, 40 feet long or more, or any other length as required to extend an entire length of roof 6. Thus, a single composite panel 65 may extend between forward portion 102 (FIG. 9) and rear portion 104 of roof 6. Also, waterproof membrane 66 and threaded fasteners 78 are optional. For example, roof 6 may comprise a single one-piece composite panel 65 with no seams 100 between adjacent composite panels 65, wherein the composite panel 65 is secured to the roof structure (e.g. trusses 36) below the composite panel with adhesive or other fastening means (e.g. without use of threaded fasteners 78) and the upper side (surface) of composite panel 65 may not be covered by a waterproof membrane.

Referring again to FIG. 4, upper and lower layers 92 and 94, respectively, of composite panel 65 may have equal or unequal thicknesses T1 and T2 in a range of about 0.010 inches to about 0.125 inches, a range of about 0.020 inches to about 0.100 inches, a range of about 0.030 inches to about 0.080 inches, and more preferably in a range of about 0.040 inches to about 0.060 inches. According to an example, thicknesses T1 and T2 are about 0.05 inches. The overall thickness T3 of composite panel 65 may be less than in inch, less than ¾ inch, or less than ½ inch. In a preferred embodiment, the overall thickness T3 is about 10 mm, or about 0.40 inches. It will be understood the thicknesses T1, T2, and T3 may vary depending on the material properties and the requirements of a particular application. The upper and lower layers 92 and 94 may be heat welded to foam core 90, or the upper and lower layers 92 and 94 may be adhesively bonded to the foam core 90.

As discussed above, threaded fasteners 78 may be driven through composite panel 65 into trusses 36 and/or sidewall structures 4 to thereby secure the composite panel 65 to the trusses 36 and/or sidewalls 4 of RV 1. Composite panel 65 preferably provides sufficient strength to prevent screws 78 from pulling through upper layer 92 when composite panel 65 is deformed (curved) as edges 96 (FIG. 5) of composite panel 65 are shifted downwardly during assembly. For example, the configuration of threaded fasteners 78 (e.g. the diameter of each screw head 79) and the construction of composite panel 65 may provide sufficient strength such that each threaded fastener 78 does not pull through or significantly damage composite panel 65 if an upward force (e.g. due to wind lift or the curvature of composite panel 65) of a predefined magnitude is applied. The predefined magnitude may comprise, for example, at least about 1 lb, at least about 5 lb, at least about 10 lb, at least about 20 lb, at least about 50 lb, or at least about 100 lb or more. Threaded fasteners 78 may comprise screws having head diameters in rage of, for example, about 0.19 inches to about 0.363 inches. Composite panels 65 preferably have sufficient bending strength to support at least one adult on roof 6 at locations between adjacent rafters/trusses 36. As noted above, trusses 36 may be positioned on, for example, 16 inch centers, 24 inch centers, 32 inch centers, or 36 inch centers. Composite panels 65 preferably have sufficient bending strength to support (without failure or damage) at least about 50 lb, at least about 100 lb, at least about 200 lb, or more preferably at least about 300 lb, when the force is applied at any location on the upper side of roof 6, including locations that are midway between adjacent rafters/trusses 36.

Also, it will be understood that composite panel(s) 65 may comprise virtually any suitable material or combination of materials. Composite panels 65 preferably provide sufficient strength to support an adult on the roof, while also providing sufficient flexibility to permit the composite panel(s) 65 to be curved to match the contour of the roof support structure (e.g. trusses/rafters 36) having a central portion that is elevated (e.g. about 2-8 inches) relative to outer portions of the roof support structure that are adjacent (e.g. directly above) upper portions of outer side walls of an RV.

Adhesive 68 preferably comprises a reactive adhesive that does not outgas, foam, or otherwise expand. As discussed in more detail below, the adhesive may comprise a two-part adhesive including a polyol component and isocyanate component that are mixed prior to applying adhesive 68 to upper layer 92 of composite panel 65. As also discussed below, the waterproof membrane 66 may optionally comprise a flexible elastomeric material such as Thermoplastic Polyolefin (TPO), Polyvinyl Chloride (PVC), Ethylene Propylene Diene Monomer (EPDM), or other suitable material. When cured, adhesive 68 may optionally have a thickness T4 of about 5 mils to about 30 or 40 mils, and more preferably about 6 mils to about 18 mils. The waterproof membrane 66 may have a thickness T5 of about 0.025 inches to about 0.010 inches, and more preferably 0.025 inches to about 0.060 inches. In a preferred embodiment, upper surface 69 of waterproof membrane 66 is white, whereby the waterproof membrane 66 reflects light to reduce increases in temperature when roof 6 is exposed to sunlight. However, it will be understood that the present disclosure is not limited to any specific waterproof membrane material or thickness.

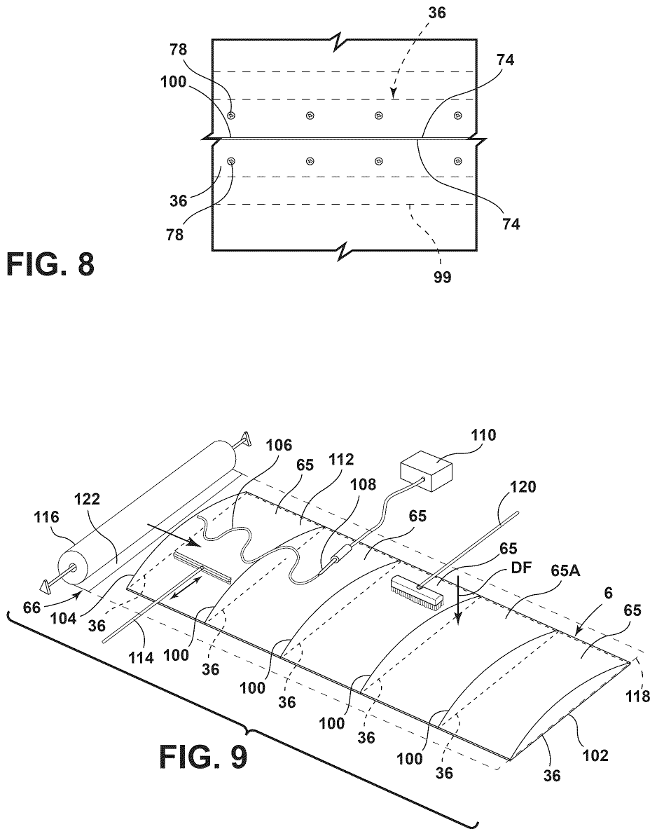

With further reference to FIGS. 4-7, during assembly, composite panel 65 is positioned above upper sides 56 of trusses 36. Adhesive may be deposited on upper sides 56 of trusses 36 to adhesively bond panel 65 to trusses 36. The adhesive may comprise, for example, construction adhesive or other suitable adhesive. A central portion 98 of composite panel 65 may be positioned against upper side 56 of trusses 36, and forces FE (FIG. 4) may be applied to composite panel 65 (FIG. 5) whereby the composite panel 65 is curved downwardly (FIG. 6). Forces FE may be applied to outer portions 60 of composite panels 65 (e.g. adjacent edges 96A, 96B of composite panels 65). A force FC may act upwardly on central portion 58 of panel 65 due to contact between panels 65 and the upper side of trusses 36. Threaded fasteners 78 may then be driven through composite panel 65 into trusses 36 and/or into wall structures 4. It will be understood that forces FE do not need to be applied simultaneously. Rather, a single force FE may be applied along the first edge 96A, and threshed fasteners 78 may be installed along the first edge 96A. A force FE may then be applied to the opposite (second) edge 96B to bring it into contact with the truss or wall structure, and fasteners 78 may then be driven through panel 65 to hold down the edge portions of panels 65. The magnitude of forces FE may be about 20 lb or less (e.g. about 2-5 lb). If a plurality of composite panels 65 are positioned adjacent to one another, the composite panels 65 may form seams 100, and threaded fasteners 78 may be driven into a truss or trusses 36 positioned below seam 100 (see also FIG. 8).

Referring again to FIGS. 4 and 5, composite panel 65 may be flat prior to installation (FIG. 4), whereby threaded fasteners 78 are utilized to position outer portions 60 of composite panel 65 closely against upper side 56 of trusses 36. Composite panel 65 may, optionally, be adhesively bonded to upper side 56 of trusses 36 or other suitable roof structure. Adhesive may be used either by itself, or in combination with, threaded fasteners 78 to secure the composite panel 65 to the trusses 36. As noted above, trusses 36 are merely an example of a suitable roof structure, and the present disclosure is not limited to roof structures having roof trusses. The curvature of composite panel 65 imposed during assembly may result in tension in upper layer 92 and compression in lower layer 94. However, the composite panels 65 may optionally be preformed to have a shape (e.g. curved) substantially conforming to curvature of upper side 56 of the trusses 36, whereby forces FE (FIG. 4) may not need to be applied to the composite panel 65 to form a curved configuration (FIGS. 6 and 7).

With further reference to FIGS. 8 and 9, a plurality of individual composite panels 65 may be positioned side-by-side on roof 6 with edges 74 of adjacent panels 65 extending along seams 100. Tape 99 may optionally be positioned over seams 100 and threaded fasteners 78. Alternatively, a single composite panel 65A extending from a forward end 102 to a rearward end 104 of roof 6 may be positioned on trusses 36 to thereby form a seamless composite roof panel that does not include seams 100.

Referring again to FIG. 9, during assembly, the adhesive 68 may be deposited on upper surface 112 of composite panel(s) 65 by spraying, or it may be dispensed to form a bead or pool 106. Adhesive 68 is preferably deposited on surface 112 before waterproof membrane 66 is positioned on roof 6. Adhesive 68 may be mixed and supplied by a machine 110 having a dispenser 108. Dispenser 108 may optionally form a bead of adhesive, or it may comprise a spray nozzle or the like. In general, machine 110 and dispenser 108 may comprise a known type of system that mixes first and second parts of a reactive adhesive in a controlled manner. Dispenser 108 may be configured to provide a bead of adhesive, or it may be configured to spray adhesive 68. According to an example, adhesive 68 may comprise a reactive two-part adhesive that is optionally mixed in equal (or unequal) volumes by machine 110. Adhesive 68 may alternatively comprise a reactive one-part adhesive. Adhesive 68 may alternatively comprise a reactive one-part adhesive. Adhesive 68 may comprise a reactive adhesive that cures or hardens based on, for example, polymerization, cross linking, or other curing that may be triggered by mixing components, heat, moisture, or ultraviolet (UV) light. Examples of reactive adhesives include epoxy adhesives (e.g. resin and hardener, 1-part polyurethane adhesive (e.g. polyurethane prepolymers that react with moisture in the air to cure), cyanoacrylate (CA) adhesive, acrylic adhesive (e.g. 2-part including adhesive and initiator, or UV curable), anaerobic adhesives, silicone adhesives, and silyl-modified polymers (e.g. silylated polyethers).

An adhesive 68 according to an aspect of the present disclosure may optionally comprise a two-part polyurethane adhesive comprising a polyol component and an isocyanate component (e.g. MDI) which react upon mixing.

According to a first example, adhesive 68 may comprise a part A having a dynamic viscosity in a range of about 200 CPS (centipoise) to about 340 CPS, and more preferably about 250 CPS to about 290 CPS, and more preferably 260 CPS to about 280 CPS. In one example. The viscosity of part A is about 068 CPS±5 CPS. Part A may have a density of about 8 lb/gal (e.g. about 8.2 lb/gal). Part A of the adhesive may comprise about 50% to about 70% castor oil by weight, and more preferably comprises about 56% to about 58% castor oil by weight. Part A may further comprise Dipropylene Glycol (DPG) in a range of about 30% to about 50% by weight, and more preferably about 35% to about 45% DPG by weight, and more preferably about 41% DPG by weight. Dipropylene Glycol (DPG) may be utilized to lower the viscosity of the polyol mixture (part A) if required. Part A may (optionally) further comprise about 1-3% Incozol® by weight. In general, the Incozol® acts as a moisture scavenger in part A. Part A of the adhesive 68 may further comprise dibutyltin dilaurate (DBTDL), which may be used as an organotin catalyst to accelerate cross linking between the isocyanate and polyol components.

According to the first example, part B of adhesive 68 may have a viscosity of about 400 CPS to about 500 CPS, and more preferably about 420 CPS to about 460 CPS, and more preferably about 440 CPS. Part B may have a density of about 10 lb/gal (e.g. about 9.94 lb/gal). Part B may optionally comprise Mondur® MR 5 isocyanate in a weight percentage of about 60% to about 80%, and more preferably about 70%. Part B may further comprise about 20% to about 40% Baytec® MP-101 isocyanate by weight, and more preferably about 30% MP-101 isocyanate by weight. It will be understood that virtually any suitable isocyanate component(s) may be utilized.

It will be understood that the present disclosure is not limited to any particular adhesive. For example, adhesive 68 may comprise a one-part adhesive, a two-part epoxy adhesive, or it may comprise a one-part or a two-part moisture curing adhesive, or it may comprise a contact adhesive that may be applied to one or both of panel 65 and membrane 66 prior to positioning membrane 66 on panel 65. Also, waterproof membrane 66 may be adhered to composite panel 65 utilizing a pressure-sensitive adhesive (PSA) that is applied to a lower side of the membrane 66 and/or to an upper side of composite panel 65 to form a thin layer of adhesive. The thin layer of adhesive may be covered with a release member or layer for storage and transportation. The release layer may then be removed to expose the PSA, and the waterproof membrane 66 may then be adhered to the upper surface of composite panel 65 via a “peel-and-stick” process. The PSA may comprise, for example, a hot-melt UV-curable adhesive that is applied to a lower side of the membrane 66 and/or to an upper side of composite panel 65 form a layer of adhesive, and the adhesive may then be at least partially cured by exposing the PSA to UV light prior to covering the partially cured PSA with a release layer. It will be understood, however, that various peel-and-stick adhesives may be utilized, and the present disclosure is not limited to a specific PSA adhesive. Thus, adhesives (e.g. s PSA adhesives) that are not UV-curable may be applied to a lower side of waterproof membrane 66 and covered with a release layer. The release layer is then removed, and the waterproof membrane is then adhered to the upper surface 80 of composite panel 65 utilizing a peel-and-stick process.

The upper layer 92 of composite panel 65 and waterproof membrane 66 may both be waterproof, such that moisture curing adhesives may not, at least in some cases, be exposed to sufficient moisture (water) prior to applying waterproof membrane 66 to ensure a proper adhesive cure. Thus, a reactive adhesive may be preferred. Nevertheless, moisture curing adhesives may be utilized according to other aspects of the present disclosure if sufficient moisture (e.g. water vapor) is present to cause curing.

Referring again to FIG. 9, after bead or pool 106 of adhesive 68 is formed or deposited on surface 112 of composite panel(s) 65, the adhesive 68 may be distributed over the surface 112 to form a thin layer of adhesive covering substantially the entire upper surface of composite panel 65. Alternatively, adhesive 68 may be spread into a thin layer on a first portion of composite panel 65 (e.g. adjacent end portion 104), and one or more additional portions of surface of 112 of composite panel(s) 65 may then be covered by a thin layer of adhesive 68. According to one example, a tool 114 may be utilized to smooth/distribute adhesive 68 that is at least partially uncured into a thin layer on surface 112. Tool 114 may comprise a paint roller, squeegee, or other suitable device or tool. Adhesive 68 may be formulated such that spreading the adhesive into a thin layer (e.g. utilizing the squeegee 114 or the like) creates a thin layer of the adhesive on surface 112 that does not react (harden) for at least, for example, about 20 minutes after mixing parts A and B to thereby provide time to position waterproof membrane 66 on the adhesive 68 on surface 112 before the adhesive cures sufficiently to impede bonding of waterproof membrane 66 to surface 112 of panel(s) 65. According to one example, adhesive 68 may have a composition that at least partially cures within about 4-6 minutes if the adhesive remains in a bead or pool. Thus, in this example, if the adhesive 68 is not spread into a thin layer (e.g. a layer that is less than about 10-30 mils thick) within about four minutes to about six minutes of mixing parts A and B, the adhesive 68 may tend to at least partially cure (harden) whereby the partially cured adhesive 68 does not permit adequate bonding of waterproof membrane 66 to composite panel 65 and/or results in bumps and/or other irregularities due to variations in the thickness of adhesive 68. Adhesive 68 may optionally be deposited (e.g. sprayed) onto upper surface of composite panel 65 to form a layer that is thin (e.g. less than about 10-30 mils thick). In such cases, it may not be necessary to spread the at least partially uncured adhesive into a thin layer to increase the cure time.

Referring again to FIG. 9, after adhesive 68 is spread into a thin layer on at least a portion of surface 112, the waterproof membrane 66 is pulled from a roll 116 and positioned over the roof 6 as shown by the dashed line 118. The waterproof membrane 66 is then positioned on surface 112 of composite panel(s) 65 in contact with the layer of adhesive 68, and a broom 120 or other suitable tool or device is then utilized to apply downward pressure or force DF onto surface 122 of membrane 66 to thereby push the membrane 66 into contact with the adhesive disposed on upper surface 112 of composite panel(s) 65. Force DF may comprise pressure that is applied to substantially the entire upper side of membrane 66 whereby the entire membrane 66 is adhesively bonded to the upper side of composite panel 65. It will be understood that virtually any suitable tools or the like may be utilized to distribute the adhesive 68 prior to applying waterproof membrane 66 and/or to apply force to the upper surface 122 of waterproof membrane 66 after the waterproof membrane 66 is positioned over the composite panel(s) 65. Also, as used herein, the term “uncured adhesive” is not limited to completely uncured adhesive, but rather denotes at least partially uncured adhesive that is sufficiently uncured to permit distribution of the adhesive 68 and/or bonding between membrane 66 and the surface of composite panel 65, as required for a specific adhesive compound, membrane material, and composite panel material.

Adhesive 68 (e.g. reactive or peel-and-stick) preferably provides sufficient strength to prevent separation of membrane 66 from composite panel(s) 65 due to wind uplift forces from wind by itself, and/or wind uplift that is generated while RV 1 is moving on a road at, for example, highway speed (e.g. 75 or 85 mph). For example, adhesive 68 may preferably provide a 180° peel strength (ASTM D903) (2 inches per minute) of at least about 1 lb/linear inch, at least about 3 or 4 lb/linear inch, at least about 10 lb/linear inch, or at least about 15 lb/linear inch. The peel strength may be tested using samples at room temperature at a plurality time intervals measured from mixing adhesive components, or from the time the membrane 66 is initially adhered to the composite panel 65. The time intervals may comprise 4 hours, 24 hours, 7 days, 14 days, 21 days, and 28 days. Some samples may remain at room temperature during all time intervals, and other samples may be placed in an oven at an elevated temperature (e.g. 70 °C) during at least some time intervals (e.g. the 7, 14, 21, and 28 day time intervals), and the samples may be tested after the samples have been removed from the oven and returned to room temperature. All such samples preferably exhibit a 180° peel strength of at least about 1 lb/linear inch. Also, one or more samples may be cold tested by positioning the samples in a test chamber at reduced temperature (e.g.-40 °C) or a time interval of, for example, 1 day, 7 days, 14 days, or 28 days, and the peel strength may be tested by removing the sample from test chamber, and attempting to manually (by hand) peel the membrane from the composite panel substrate before the temperature of the sample increases significantly. Preferably, the membrane cannot be removed manually when the sample is at or near −40 °C (e.g. within a range of −35 °C to-40 °C).

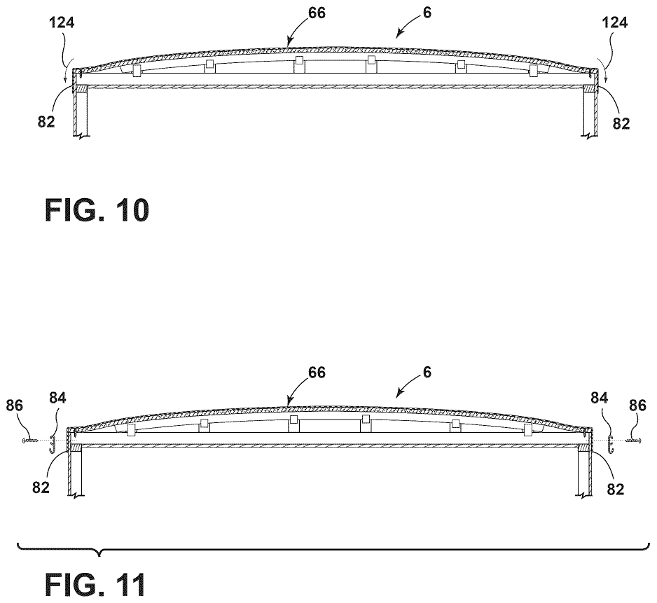

With further reference to FIGS. 10 and 11, during assembly flaps or edges 82 of membrane 66 may be wrapped around the outer edges 124 of roof 6, and edges 82 of membrane 66 may be secured to the upper portions of the walls utilizing two-sided tape. Drip rails 84 are then secured to the walls 4 over the edges 82 utilizing threaded fasteners 86.

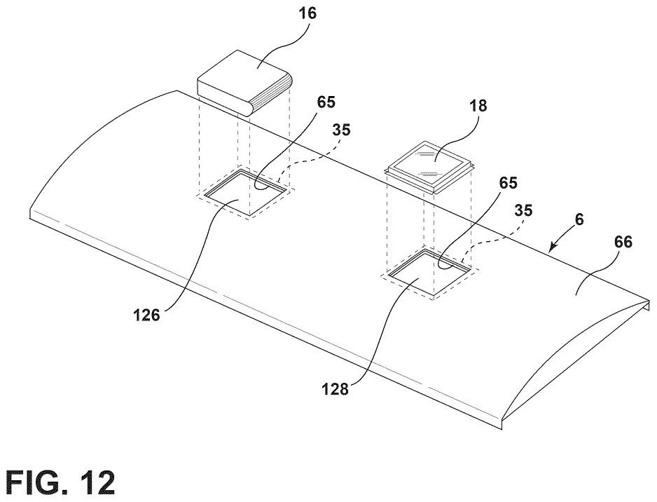

With further reference to FIG. 12, after the waterproof membrane 66 is installed, openings 126 and 128 may be cut in the waterproof membrane 66 and composite panels 65, and one or more items such as AC unit 16 and/or skylight 18 may be positioned in openings 126 and 128. As noted above, frame members 35 may be positioned adjacent to the AC unit 16, skylight 18, other items to provide reinforcement in addition to the trusses 36.

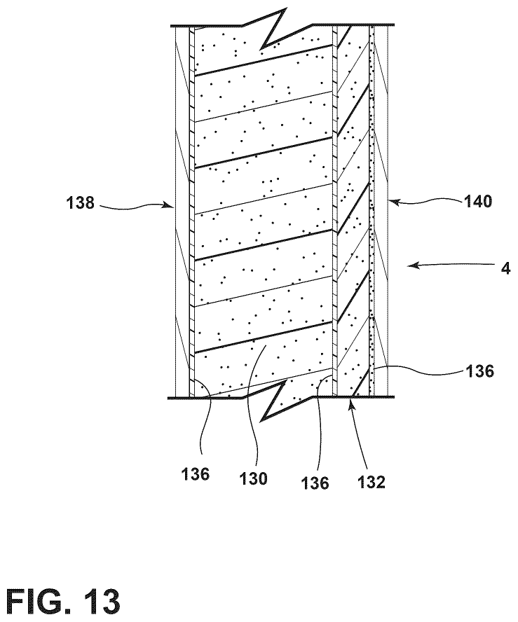

With further reference to FIG. 13, the wall structures 4 may optionally comprise a foam core 130 that is disposed between upright frame members 34 (FIG. 1). Interior wall panels 138 may be positioned on an inner side of frame members 34 (FIG. 1) and foam core 130. Interior wall panels may be secured to frame member 35 and/or foam core 130 utilizing adhesive 136. Panels 132 and 140 may be positioned on an outer side of wall 4. Panel 132 may comprise a blend of polypropylene and fiberglass (e.g. a polypropylene matrix having glass fibers disposed in the matrix), and panels 140 may comprise fiberglass (e.g. a thermosetting matrix with glass fibers disposed in the matrix). Panels 140 may alternatively comprise metal (e.g. aluminum).

With further reference to FIG. 14, slide out 140 may include a roof 142 and a floor 144. Roof 142 may include a composite panel 165 having substantially the same construction as composite panel 65. For example, panel 165 may have a foam core 190, corresponding to foam core 90, and polymer upper and lower layers 192 and 194, corresponding to upper and lower layers 92 and 94, respectively, of composite panel 65. Roof 142 may optionally include a flat roof support structure 172 having a flat upper surface 174 that may optionally be adhered to flat lower surface 176 of composite panel 165. Roof 142 may optionally include a waterproof membrane 166 that is adhered to composite panel 165 by adhesive 168 in substantially the same manner as discussed above in connection with membrane 66, panel 65, and adhesive 168. However, in contrast to roof 6, roof 142 may be substantially flat, whereby composite panel 165 remains flat both before and after assembly of slide out 140. Floor 144 may comprise a panel 22 having a foam core 26A and upper and lower layers 28A and 28B, respectively, corresponding to core 26 and layers 28, as described in more detail above in connection with FIG. 2.

It will be apparent to those skilled in the art that various modifications and variations can be made without departing from the spirit or scope of the claims.

What is claimed is:

1. A composite panel for roof structures of recreational vehicles, the composite panel comprising:
a thermoplastic polymer foam core disposed between an upper layer and a lower layer, wherein the upper and lower layers each comprise glass fibers disposed in a polymer matrix, the glass fibers extending in first and second directions, respectively, wherein the first direction is transverse relative to the second direction; and:
wherein the composite panel is configured to be deformed during assembly of the roof structure, whereby side portions of the composite panel adjacent opposite portions of the roof support structure are secured to the roof support structure such that the composite panel defines a curvature and a central portion of the composite panel is elevated relative to the side portions of the composite panel.

2. The composite panel of claim 1, wherein:
the thermoplastic polymer foam core comprises polyethylene terephthalate (PET) foam.

3. The composite panel of claim 1, wherein:
the glass fibers of the upper and lower layers are disposed in a thermoplastic polymer matrix.

4. The composite panel of claim 1, wherein:
the glass fibers comprise non-woven fiberglass.

5. The composite panel of claim 1, wherein:
the glass fibers comprise woven fiberglass.

6. The composite panel of claim 1, wherein:
the composite panel has a thickness of less than ½ inch.

7. The composite panel of claim 6, wherein:
the composite panel has a thickness of 0.4 inches.

8. The composite panel of claim 1, wherein:
the upper layer has a thickness of 0.010 inches to 0.125 inches; and:
the lower layer has a thickness of 0.010 inches to 0.125 inches.

9. The composite panel of claim 1, wherein:
the polymer foam core comprises closed cell foam.

10. The composite panel of claim 1, wherein:
the composite panel is adapted to be installed on the roof structure with the upper layer of the composite panel in tension due to the curvature, and the lower layer of the composite panel in compression due to the curvature.

11. The composite panel of claim 1, wherein:
the side portions of the composite panel are adapted to be adhesively secured to the roof support structure without the use of threaded fasteners.

12. The composite panel of claim 1, wherein:
the polymer foam core comprises closed cell PET foam having a density of 2-10 pounds per cubic foot.

13. The composite panel of claim 1, wherein:
the upper and lower layers comprise greater than 50% polymer matrix material by weight, and less than 50% glass fibers by weight.

14. The composite panel of claim 1, including:
a membrane bonded to an upper side of the upper layer of the composite panel.

15. The composite panel of claim 1, wherein:
the composite panel is adapted to be installed on the roof structure whereby the central portion of the composite panel is elevated at least two inches relative to the side portions of the composite panel.

16. The composite panel of claim 1, including:
a membrane bonded to the upper layer of the composite panel, the membrane including opposite edges that extend beyond opposite outer edges of the composite panel to form flaps that are adapted to be deformed downwardly to cover the opposite outer edges of the composite panel.

17. A recreational vehicle including the composite panel of claim 1, including:
a flexible waterproof membrane adhesively bonded to the upper layer of the composite panel by reactive adhesive that cures via a chemical reaction, and wherein:
the adhesive comprises first and second parts that are mixed to create a chemical reaction that causes the adhesive to cure without evaporation or outgassing; and:
the adhesive comprises a polyol component and a Methyl Isocyanate component that react upon mixing.

18. A recreational vehicle including the composite panel of claim 1, wherein:
the composite panel comprises a unitary one-piece structure that extends from a front portion of the recreational vehicle to a rear portion of the recreational vehicle.

19. The recreational vehicle of claim 18, wherein:
the roof support structure comprises a plurality of trusses extending between upright side walls of the recreational vehicle; and:
the composite panel extends over the plurality of trusses.

20. A method of installing a composite roof on a curved roof support structure of a recreational vehicle (RV), the method comprising:
positioning at least one composite panel over the roof support structure, wherein the composite panel comprises a unitary one-piece structure that extends from a front portion of the RV to a rear portion of the RV with opposite outer edges of the composite panel extending between the front and rear portions of the RV, and wherein the roof support structure includes: 1) side portions that are adjacent upright side walls of the RV, and 2) a central portion that is elevated relative to the side portions;
bonding a top layer of material to the upper layer of the composite panel whereby edge portions of the top layer of material extend outwardly beyond the opposite outer edges of the composite panel to form flaps;
wherein the composite panel comprises a thermoplastic polymer foam core disposed between an upper layer and a lower layer, wherein the upper and lower layers each comprise glass fibers disposed in a polymer matrix, the glass fibers extending in first and second directions, respectively, wherein the first direction is transverse relative to the second direction, and wherein the composite panel has a thickness of less than ½ inch;
deforming the composite panel by securing side portions of the composite panel to the roof structure of the RV whereby: 1) a central portion of the composite panel above the central portion of the roof structure is elevated at least two inches relative to the side portions of the composite panel, 2) the upper layer of the composite panel is in tension due to the curvature, 3) the lower layer of the composite panel is in compression due to the curvature, and: 4) the composite panel is secured to the curved roof support structure utilizing adhesives, without the use of mechanical fasteners; and:
deforming the flaps of the top layer of material downwardly to cover the opposite outer edges of the composite panel.

21. The method of claim 20, wherein:
the top layer of material comprises a flexible waterproof membrane.
